(19) United States
(12) Patent Application Publication
(10) Pub. No.: US 2022/0087793 A1
(43) Pub. Date: Mar. 24, 2022

(54) METHODS AND SYSTEMS FOR DESIGNING DENTAL SPLINTS

(71) Applicant: Great Lakes Dental Technologies, Ltd., Tonawanda, NY (US)

(72) Inventor: Tyler Sisson, Buffalo, NY (US)

(21) Appl. No.: 17/480,106

(22) Filed: Sep. 20, 2021

Related U.S. Application Data
(60) Provisional application No. 63/080,743, filed on Sep. 20, 2020.

(51) Int. Cl. A61C 13/00; B33Y 50/00; B33Y 80/00; B29C 64/386

(52) U.S. Cl. CPC A61C 13/0019; B33Y 50/00; A61C 5/007; B29C 64/386; B33Y 80/00

(57) ABSTRACT

The present disclosure provides systems and methods for designing a dental splint for an individual. For example, a method may include obtaining a digital 3D model of a dentition of the individual. An insertion direction is determined for the dentition. The method includes determining a height of contour for one or more teeth of the dentition based on the insertion direction. A cut line of the dental splint is identified based on a retention amount as a distance apically beyond the height of contour of the one or more teeth of the dentition.

### CROSS-REFERENCE TO RELATED APPLICATIONS

This application claims priority to U.S. Provisional Application No. 63/080,743, filed on Sep. 20, 2020, now pending, the disclosure of which is incorporated herein by reference.

### FIELD OF THE DISCLOSURE

The present disclosure relates to dental splints, and more particularly to computer-aided design of dental splints.

### BACKGROUND OF THE DISCLOSURE

Currently, production of dental splints, such as, for example, deprogrammer splints used for individuals with bruxism or TMJ, is accomplished using materials and processes that do not lend themselves to automation. For example, in some processes, a splint is thermoformed over a cast of the individual's dentition and manually trimmed by a technician using the cast as a guide for a proper fit. Often, a dental splint is trimmed at or near the gingival margin (see, e.g., dashed line in FIG. 6). For some exemplary fabrication techniques, a bite plane material may then be bonded to the device and shaped and trimmed manually.

There is a need for techniques which enable more automated processes for manufacturing a dental splint.

### BRIEF SUMMARY OF THE DISCLOSURE

In an aspect, the present disclosure may be embodied as a method, such as a computer-implemented method, for designing a dental splint for an individual. The method includes obtaining a digital 3D model of a dentition of the individual. An insertion direction is determined for the dentition. The insertion direction may be, for example, normal to an occlusal plane of the dentition. In another example, the insertion direction is parallel to the teeth of the dentition (e.g., to an axis derived from a primary axis of each tooth, etc.) The method includes determining a height of contour for one or more teeth of the dentition based on the insertion direction. The height of contour may be determined on a lingual side of the dentition and/or a facial side of the dentition. A cut line of the dental splint is identified based on a retention amount as a distance apically beyond the height of contour of the one or more teeth of the dentition. In some embodiments, the retention amount is pre-determined based on a selected dental splint material. In some embodiments, the retention amount is between 0.25 mm and 0.35 mm, inclusive. As an example, such a retention amount range may be suitable for nylon.

The method may include fabricating the dental splint, wherein the fabricated dental splint has an extent at the cut line. For example, the dental splint may be fabricated using additive manufacturing, such as, for example, using a 3D printer. In some embodiments, the dental splint is cut at the cut line. For example, a 3D printed splint may be printed with a shape that extends beyond the cut line, and a manufacturing step may include cutting (e.g., trimming) the dental splint at the cut line.

In another aspect, the present disclosure may be embodied as a system for designing a dental splint for an individual. The system may include a processor in electronic communication with a storage device. The processor may be configured to perform any method of the present disclosure. For example, the processor may be configured to obtain a 3D model of a dentition of the individual; determine an insertion direction for the dentition; determine a height of contour of one or more teeth of the dentition based on the insertion direction; and identify a cut line of the dental splint based on a retention amount as a distance apically beyond the height of contour of the one or more teeth of the dentition. The 3D model may be obtained from the storage device, an intra-oral scanner, scanning a cast model, etc. The system may further include a 3D printer in electronic communication with the processor.

In another aspect, the present disclosure may be embodied as a non-transitory computer-readable storage medium having stored thereon processor-executable instructions configured to cause a processor to perform any of the methods of the present disclosure. For example, the medium may include instructions to cause a processor to: obtain a digital 3D model of a dentition of the individual; determine an insertion direction for the dentition; determine a height of contour for one or more teeth of the dentition based on the insertion direction; and identify a cut line of the dental splint based on a retention amount as a distance apically beyond the height of contour of the one or more teeth of the dentition.

### DESCRIPTION OF THE DRAWINGS

For a fuller understanding of the nature and objects of the disclosure, reference should be made to the following detailed description taken in conjunction with the accompanying drawings, in which:

FIG. 1 is an illustration of a 3D model of a dentition of an individual;

FIG. 2 is an illustration showing an insertion direction determined for the dentition of FIG. 1;

FIG. 3 shows a blockout of the dentition of FIG. 1, wherein the blockout is based on a retention amount of 0.55 mm;

FIG. 4 shows a lingual view of the blockout of FIG. 3;

FIG. 5 shows a cut line identified for the dentition and blockout of FIG. 3;

FIG. 6 shows a cut line of a prior art method for designing dental splints;

FIG. 7 is a chart showing a method for designing dental splints according to an embodiment of the present disclosure; and

FIG. 8 is a diagram of a system according to an embodiment of the present disclosure.

### DETAILED DESCRIPTION OF THE DISCLOSURE

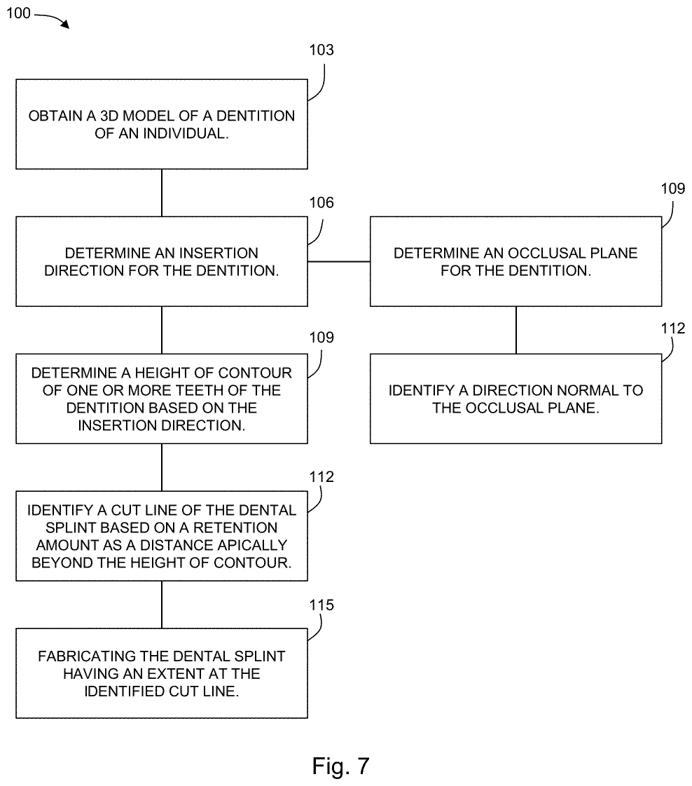

With reference to FIG. 7, in a first aspect, the present disclosure may be embodied as a method 100 for designing a dental splint for an individual. The method 100 includes obtaining 103 a digital three-dimensional (3D) model of a dentition of the individual. In some embodiments, the model is obtained by intra-oral scanning of the individual. In some embodiments, the model is obtained by scanning a cast of the dentition of the individual (e.g., a plaster cast made from a mold of the dentition, etc.) In some embodiments, the 3D model is obtained as a file from a storage or communication device (e.g., an electronic file). For example, the file may have previously been created by intraoral scanning, scanning a cast, etc. The 3D model may be obtained in using any of the many techniques known now or developed in the future.

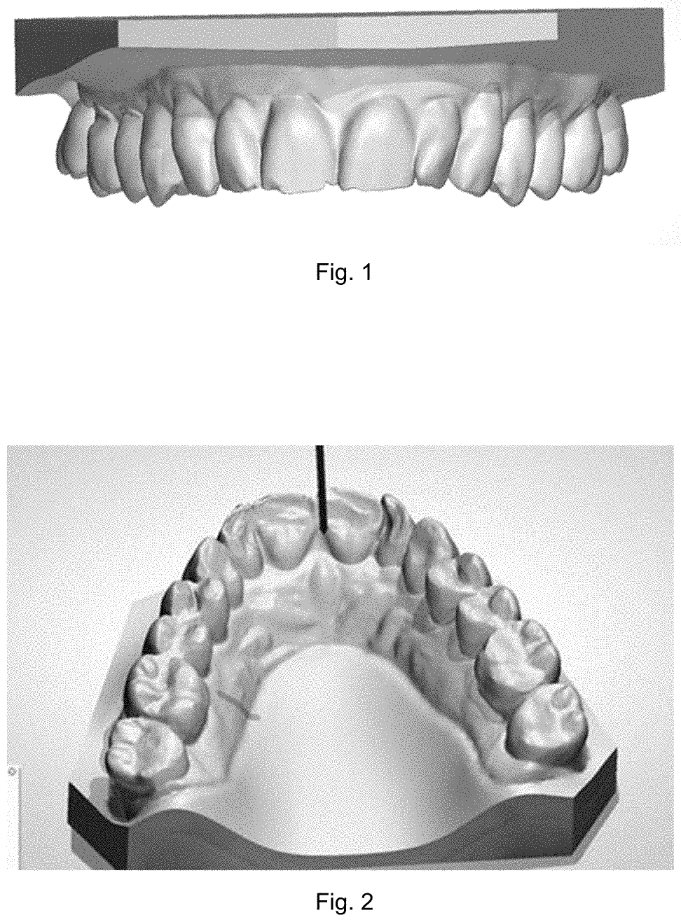

An insertion direction is determined 106 for the dentition. The insertion direction is the direction that the splint will be positioned onto the dentition by, for example, the patient. The insertion direction may be determined by identifying an occlusal plane and choosing a direction normal to the occlusal plane. Techniques for identifying an occlusal plane of a dentition are known in the art. In another example, the insertion direction may be determined as a direction parallel to a long axis (i.e., the coronoapical axes) of the teeth of the dentition. While it is understood that the coronoapical axes of the teeth of a dentition may not be parallel with one another, the insertion direction may be determined based on these axes (e.g., an average of the various axes, an average of a subset of the axes (e.g., central incisors, etc.), or other ways). FIG. 2 shows an arrow indicating the determined insertion direction for the dentition of FIG. 1.

A height of contour of the teeth is determined 109 for the dentition based on the insertion direction. The height of contour is a measure of the farthest extent of the tooth from its root axis line (in some embodiments, measured in a direction normal to the insertion direction). The height of contour may be determined in various ways. In some embodiments, a projection, for example, a virtual projection using a computer, is used along the insertion direction to determine a shadow or “blockout.” In some embodiments, the height of contour is determined based on the extent of the tooth further from its root axis line. The height of contour is generally shown where the blockout intersects with the teeth. In some cases, the height of contour may not be readily apparent because the gum line may be above the height of contour. The height of contour may be determined on a lingual side and/or a facial side of the dention.

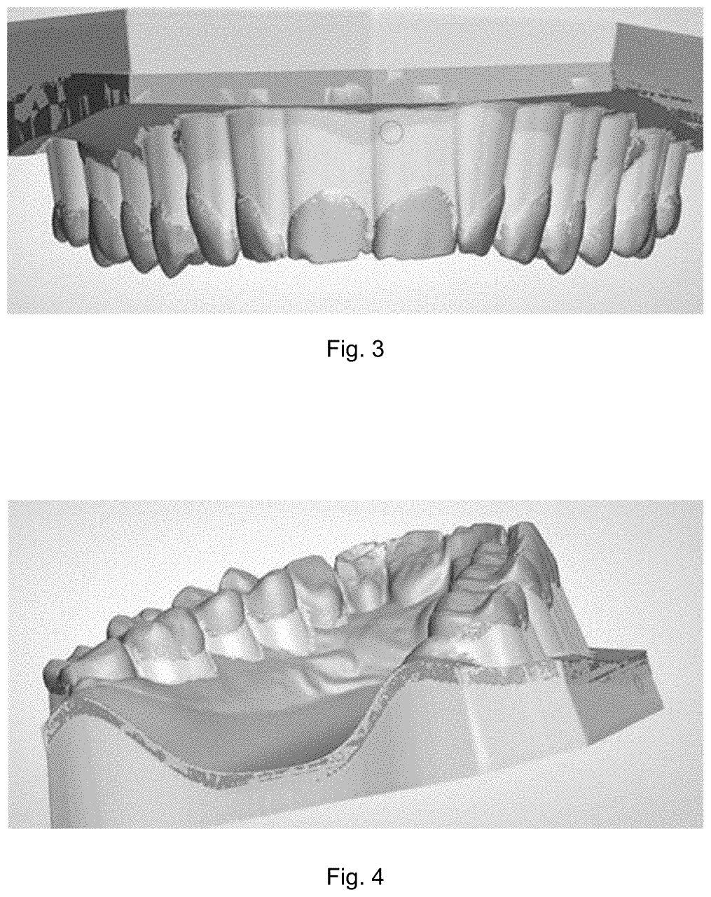

The method 100 includes identifying 112 a cut line of the dental splint. The cut line is identified 112 based on a retention amount, where the retention amount is a distance apically beyond the determined 109 height of contour. In this way, the dental splint is designed to extend slightly beyond the height of contour of one or more teeth of the dentition such that the dental splint is retained on the teeth once inserted. It should be noted that the apical direction is generally towards the root of the tooth. As such, apically beyond is intended that the cut line is located on the root side of the height of contour. The retention amount may be pre-determined or manually selected. In some embodiments, the retention amount is pre-determined according to a material to be used for the dental splint in order for the dental splint to securely held to the dentition while also allowing removal when desired. For example, softer materials may require a larger retention amount, whereas harder materials may require a smaller retention amount. In test embodiments, a retention amount of between 0.25 mm and 0.35 mm, inclusive, has been found to be acceptable for dental splints made from Nylon. This range is intended to be exemplary and other retention amounts may be used for Nylon or other materials. Other suitable materials for such a splint (and the characteristics of such materials—e.g., relative hardness) are known in the art. In some embodiments, the cut line is identified automatically (e.g., by software). In some embodiments, the cut line is manually identified with the aid of a displayed dentition, with guides indicating a blockout, a retention amount, and/or a height of contour. For example, the dentition may be displayed on a computer display and showing a blockout adjusted by a retention amount (for example, as shown in FIG. 3), and a user may identify the cut line using an input device such as, for example, a mouse, stylus, touch screen, etc.

FIG. 3 depicts a blockout (with a retention amount) on the facial side of the dentition of FIG. 1, where the blockout is shown in the lighter gray and the dentition is shown as a darker gray. FIG. 4 shows the blockout on the labial side of the dentition. It can be seen that the blockout intersects the teeth at a position apically from the height of contour because the blockout in the figures is offset by the retention amount (in this example, 0.55 mm).

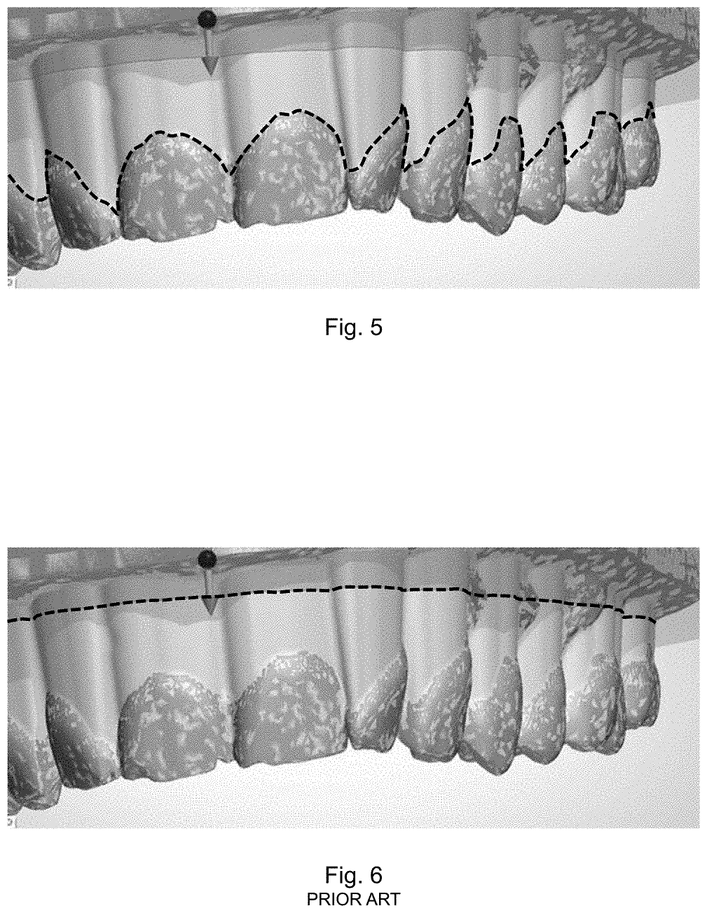

FIG. 5 shows a cut line (dashed black line) identified based on the retention amount from the height of contour of the exemplary dentition. In some embodiments, the cut line is identified based on the retention amount for a subset of teeth of the dentition. By a cut line identified based on the retention amount, it is intended that the cut line identified in this way is at a location apically beyond the height of contour by the retention amount or generally at a location apically beyond the height of contour by the retention amount (e.g., generally meaning that the cut line may be smoothed to prevent uncomfortable (for example, sharp) geometries). The cut line at the other teeth of the dentition (i.e., other than the subset where the cut line is at the retention amount) may be determined using any other technique, including arbitrarily determined. For example, in various embodiments, the cut line may be determined based on the retention amount for one, two, three, four, five, six, seven, eight, nine, or ten teeth of the dentition or more. FIG. 6 shows an exemplary cut line determined according to a traditional technique where the cut line is selected to be generally along a plane parallel to the occlusal plane (and apically located relative to the height of contour).

In some embodiments, the method 100 further includes fabricating 115 the dental splint. The fabricated 115 dental splint has an extent at the identified 112 cut line. For example, the dental splint may be fabricated using additive manufacturing. In another example, the dental splint is fabricated using subtractive techniques (e.g., machined, etc.) and the dental splint is cut at the cut line.

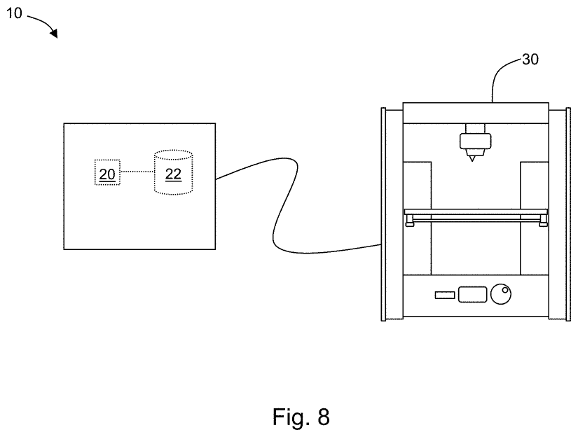

With reference to FIG. 8, in another aspect, the present disclosure may be embodied as a system 10 for designing a dental splint for an individual. The system 10 includes a processor 20 and a storage 22 device (e.g., non-transitory medium) in electronic communication with the processor 20. The processor 20 may be configured to perform any of the methods disclosed herein. In an exemplary embodiment, the processor may be configured to obtain a 3D model of a dentition. For example, the processor may obtain the 3D model from the storage device. Continuing the exemplary embodiment, the processor determines an insertion direction for the dentition and determines a height of contour based on the insertion direction. The processor may identify a cut line of the dental splint based on a retention amount as a distance apically beyond the height of contour of one or more teeth. In some embodiments, the processor identifies the cut line automatically (e.g., without guidance by a user). In some embodiments, the processor identified the cut line by receiving the cut line from a user. For example, the processor may display the dentition on a computer display, and a user may use an input device (mouse, stylus, touch screen, etc.) to indicate the location of the cut line based on the retention amount.

Although described as a processor, it is to be appreciated that the processor may be implemented in practice by any combination of hardware, software, and firmware. Also, its functions as described herein may be performed by one unit, or divided up among different components, each of which may be implemented in turn by any combination of hardware, software and firmware. Program code or instructions for the processor to implement the various methods and functions described herein may be stored in processor readable storage media, such as memory.

In some embodiments, the system includes a device 30 for fabricating the dental splint. For example, the system may include a 3D printer, a CNC machine, or any other suitable fabrication device, in electronic communication with the processor. The device may be a device suitable for additive manufacturing. The device may be a device suitable for subtractive manufacturing. In some embodiments, the device can be used for both additive and subtractive manufacturing.

In another aspect, the present disclosure may be embodied as a non-transitory computer-readable storage medium having stored thereon processor-executable instructions configured to cause a processor to perform operations representing any of the methods disclosed herein. For example, the storage medium may have instructions to cause a processor to obtain a digital 3D model of a dentition of the individual; determine an insertion direction for the dentition; determine a height of contour for one or more teeth of the dentition based on the insertion direction; and identify a cut line of the dental splint based on a retention amount as a distance apically beyond the height of contour of the one or more teeth of the dentition.

Although the present disclosure has been described with respect to one or more particular embodiments, it will be understood that other embodiments of the present disclosure may be made without departing from the spirit and scope of the present disclosure.

We claim:

1. A method for designing a dental splint for an individual, comprising:
obtaining a digital 3D model of a dentition of the individual;
determining an insertion direction for the dentition;
determining a height of contour for one or more teeth of the dentition based on the insertion direction; and
identifying a cut line of the dental splint based on a retention amount as a distance apically beyond the height of contour of the one or more teeth of the dentition.

2. The method of claim 1, further comprising fabricating the dental splint, wherein the fabricated dental splint has an extent at the cut line.

3. The method of claim 2, wherein the dental splint is fabricated using additive manufacturing.

4. The method of claim 2, wherein the dental splint is cut at the cut line.

5. The method of claim 1, wherein the insertion direction is normal to an occlusal plane of the dentition.

6. The method of claim 1, wherein the insertion direction is parallel to the teeth of the dentition.

7. The method of claim 1, wherein the height of contour is determined on a lingual side of the dentition.

8. The method of claim 1, wherein the height of contour is determined on a facial side of the dentition.

9. The method of claim 1, wherein the retention amount is pre-determined based on a selected dental splint material.

10. The method of claim 9, wherein the retention amount is between 0.25 mm and 0.35 mm, inclusive, for nylon.

11. The method of claim 1, wherein the cut line is identified automatically.

12. The method of claim 1, wherein the cut line is identified by a user.

13. A system for designing a dental splint for an individual, comprising:
a storage device;
a processor in electronic communication with the storage device, wherein the processor is configured to:
obtain a 3D model of a dentition of the individual;
determine an insertion direction for the dentition;
determine a height of contour of one or more teeth of the dentition based on the insertion direction; and
identify a cut line of the dental splint based on a retention amount as a distance apically beyond the height of contour of the one or more teeth of the dentition.

14. The system of claim 13, further comprising a 3D printer in electronic communication with the processor.

15. A non-transitory computer-readable storage medium having stored thereon processor-executable instructions configured to cause a processor to perform operations comprising:
obtaining a digital 3D model of a dentition of the individual;
determining an insertion direction for the dentition;
determining a height of contour for one or more teeth of the dentition based on the insertion direction; and
identifying a cut line of the dental splint based on a retention amount as a distance apically beyond the height of contour of the one or more teeth of the dentition.
